(19) United States
(12) Patent Application Publication
(10) Pub. No.: US 2012/0327313 A1
(43) Pub. Date: Dec. 27, 2012

(54) Wallpaper Projection System

(76) Inventors: Dean Thompson, Punta Gorda, FL (US); Holly Markland, Punta Gorda, FL (US)

(21) Appl. No.: 13/534,587

(22) Filed: Jun. 27, 2012

Related U.S. Application Data
(60) Provisional application No. 61/501,354, filed on Jun. 27, 2011.

(51) Int. Cl. H04N 9/31; G03B 21/14

(52) U.S. Cl. 348/744; 353/79; 348/E09.025

(57) ABSTRACT

A wall projection system for a room comprising a projector, where the projector is mounting on the ceiling of a four-walled room; at least one projection lens directed from the projector to each wall of the room, where the projection lens projects an image; and a screen type covering for each wall, where the screen type covering receives the image projected from the projection lens. The projector is mounted to a center point of the ceiling, to allow the projection lenses to project the images onto a screen-type wallpaper on the walls. The image projected is a single panoramic image projected onto each of the walls of the room.

### CROSS REFERENCE TO OTHER APPLICATIONS

This application claims priority to U.S. Provisional Application Ser. No. 61/501,354 filed on Jun. 27, 2011.

### BACKGROUND OF THE INVENTION

1. Field of the Invention

The present invention relates to a projection system that is utilized to project scenes upon four adjoining walls in a room.

2. Description of Related Art

A video projection device is used to display visual images on a projection screen and typically used for home video display. The home video display normally relates to either a televised event or the viewing of a motion picture. Projection screens are designed in various sizes and in many cases may be installed to cover an entire wall surface in a particular area. The screen may be either white or gray in order to avoid any discoloration of the image, where the brightness of the screen depends on ambient light levels and luminous power of the image source. Projectors for such screens may be table mounted overhead projectors or slide projectors where the projector displays the image over the screen. Further related prior art includes video walls where the wall includes a video display and the display utilizes panels or paneling that provides a LED array, a LCD panel or other rear projection means. In the case of a video wall, the wall may be used as a large screen, where the image is displayed on the screen by a rear projection or LED technology. The screen may consist of multiple monitors or one large single monitor. The number of screens or monitors utilized may vary based upon application and the size of the room.

It would be advantageous to utilize video display to create a consistent interchangeable image for adjoining walls in a single room. Such a device could provide substitute for traditional wall coverings such as wallpaper or basic paint.

### SUMMARY OF THE INVENTION

In view of the foregoing disadvantages inherent in the prior art, the general purpose of the present invention is to provide a wall projection system, configured to include all of the advantages of the prior art, and to overcome the drawbacks inherent therein.

Accordingly, an object of the present invention is to provide a wall projection system that projects onto multiple walls of a room.

Another object of the present invention is to provide a wall projection system that projects a single panoramic image onto multiple walls of a room.

To achieve the above objects, in an aspect of the present invention, a wall projection system is described comprising a projector, where the projector is mounting on the ceiling of a four-walled room; at least one projection lens directed from the projector to each wall of the room, where the projection lens projects an image; and a screen type covering for each wall, where the screen type covering receives the image projected from the projection lens. The projector is mounted to a center point of the ceiling, to allow the projection lenses to project the images onto a screen-type wallpaper on the walls. The image projected is a single panoramic image projected onto each of the walls of the room.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawing in which:

FIG. 1 depicts a wall projection system in accordance with the present invention.

### DETAILED DESCRIPTION OF THE DRAWINGS

The present invention relates to a wall projection system that depicts a panoramic image over four adjoining walls in a single room. The projection system is ceiling mounted with projection lenses directed towards each wall in a four-walled room. The projection system according to the present invention helps to provide a decorative image across the four walls in any desired scene by the user. This projection system enables the user to easily change the scenery within a room and therefore may change the atmosphere of the room. The projection lens is provided on the system according to the present invention projects images that render scenery upon the four walls within a single room.

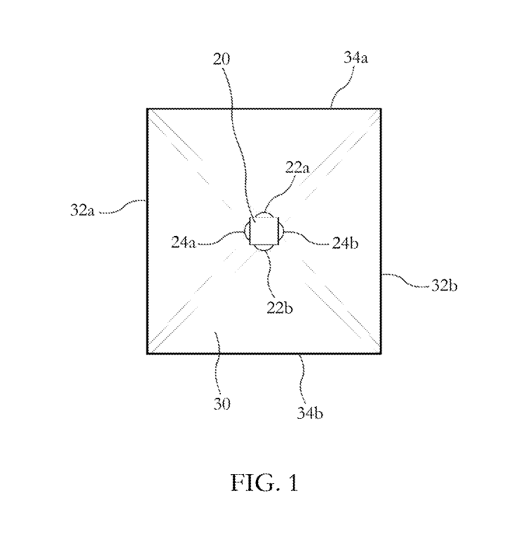

In reference to FIG. 1, the projection system according to the present invention is depicted. The projection system includes a Projector 20 mounted upon a Ceiling 30 as shown in FIG. 1. The Projector 20 is centered at a center point of the Ceiling 30 to facilitate the projection of images on each wall of the room. The projection system according to the present invention may be utilized in a four-sided or four-walled room as shown in FIG. 1. Walls 32a, 32b and Walls 34a, 34b adjoin each other to create the room for use with the Projector 20. Each wall receives an image from one of the projection lenses provided on the Projector 20. Projection screen-type wallpaper is provided on each Walls 32a, 32b and Walls 34, 34b, where each wall receives a video image transmitted by the Projector 20. A projection lens is directed toward each wall. As shown, Projection Lens 22a directs an image toward Wall 34a, Projection Lens 24b directs an image toward Wall 32b, Projection Lens 22b directs an image towards Wall 34b and Projection Lens 24a directs an image towards Wall 32a. The images provided on the walls correspond to a single panoramic image that transfers and connects through the adjoining walls. This imagery provided by the Projector 20 helps create an innovative, decorative system for images upon the walls of the room. (game display, insert discs, media on

The Projector 20 may be powered through the electrical system of the residence where the projector is installed. Images provided on each wall are typical images that may be shown through the projectors that are known in the art. The Projector 20 of the present invention includes mechanisms and software that enables the joining of the images for a panoramic view on the adjoining walls. The projection system according to the present invention of course is interchangeable and enables the user to interchange the specific scenery as desired by inputting various desired images within the Projector 20. Also, the Projector 20 may include a timing mechanism wherein the timing mechanism changes the scenery or images projected based upon a predetermined timed interval.

The foregoing descriptions of specific embodiment of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A wall projection system for a room comprising:
a. a projector, where the projector is mounting on the ceiling of a room;
b. at least one projection lens directed from the projector to each wall of the room, where the projection lens projects an image; and
c. a screen type covering for each wall, where the screen type covering receives the image projected from the projection lens.

2. The wall projection system for a room according to claim 1, where the room includes 4 walls.

3. The wall projection system for a room according to claim 1, where the projector is mounted to a center point of the ceiling.

4. The wall projection system for a room according to claim 1, where the screen type covering is a screen type wallpaper.

5. The wall projection system for a room according to claim 1, where the image is a single panoramic image projected onto each of the walls of the room.

6. The wall projection system for a room according to claim 1, where the projector is powered by an electrical system of the room.

7. The wall projection system for a room according to claim 1, where the image is interchangeable with other images changed as desired by a user.

8. The wall projection system for a room according to claim 1, where the projector includes a timing mechanism, where the timing mechanism changes images projected based upon a predetermined timed interval.

9. The wall projection system for a room according to claim 1, where the image is a video image.
